(19) United States
(12) Patent Application Publication
(10) Pub. No.: US 2004/0022902 A1
(43) Pub. Date: Feb. 5, 2004

(54) High-protein and low-calorie dough for making products imitating bread-type products, and preparation method

(76) Inventor: Reginald Allouche, Paris (FR)

Correspondence Address: PIPER RUDNICK, P. O. BOX 64807, CHICAGO, IL, 60664-0807, US

(21) Appl. No.: 10/297,413

(22) PCT Filed: Jun. 6, 2001
(86) PCT No.: PCT/FR01/01744

(30) Foreign Application Priority Data
Jun. 7, 2000 (FR) 00/07468

(51) Int. Cl. A23G 3/00

(52) U.S. Cl. 426/94

(57) ABSTRACT

The invention concerns a high-protein and low-calorie food preparation in the form of a dough adapted to be shaped, in particular into rolls, balls, patties, or baguettes, for making products imitating or resembling traditional bread-type products, and having, the percentages being expressed in weight of the commercialised product: a total protein content (measured in N×6.25) ranging between 5 and 25%, preferably between 6 and 23%, and more preferably between 7 and 22%; carbohydrate content ranging between 10 and 27%, preferably between 10 and 26%, and more preferably between 11 and 25%; a lipid content ranging between 0.01 and 2%, preferably between 0.05 and 2%, and more preferably between 0.09 and 1.75%; a water content from 45 to 70%. The invention also concerns the bakery products obtained by using said food preparation.

The subject of the present invention is a food preparation in the form of dough suited to shaping, in particular into rolls, balls, patties or baguettes, which may be provided at room temperature (packaging under a controlled atmosphere, for example) or in a deep-frozen state. This food preparation is intended to be baked or simply heated at the time of consumption, in order to give products imitating or resembling traditional bread-type products, and it is characterized by a high content of proteins and a low content of carbohydrates and of lipids. It is therefore both high in protein and low in calories.

The invention also relates to the bakery products obtained using this food preparation.

Traditional bread-type products, such as baguettes, bread balls, sandwich bread slices, and the like are, par excellence, products which are difficult to integrate into a diet because, although they do not necessarily initially contain a high level of lipids, their high content of carbohydrates markedly restricts their consumption.

While it is evident that consumers are increasingly mindful of their physical appearance and that they do not therefore wish to gain weight, it is also true that they nevertheless wish to continue to enjoy eating, that is to say by eating tasty products to satiety. They are therefore increasingly led to turn to multiple so-called “slimming” diets which are most generally characterized by a lower daily calorie intake, obtained by a lower quantity of ingested foods which is most often associated with a reduction in the content of lipids.

Unfortunately, these diets are difficult to adhere to over a long period and cause a loss of weight linked to a loss of muscle mass. A lack of skin tone and elasticity, and a physical and intellectual asthenia are then observed. In addition, people strictly following these diets do not eat as much as they would like to and therefore suffer from hunger and feel frustrated.

A need therefore exists to have diet products which, while being low in calories, do not cause the harmful consequences indicated above and which allow the consumer to follow a diet with pleasure, that is to say which allow them to eat to satiety and to lose their fatty mass, without this being at the expense of their lean mass.

It is recognized that it would be necessary to provide the body, during these periods of calorie reductions, with a higher supply of proteins of high nutritional and biological value.

However, this additional constraint further complicates the exercise of formulating food compositions which are, at the same time, low in calories, industrializable, organoleptically satisfactory, stable from the point of view of aging and which are easy to prepare, without adding fat.

This is even more arduous in the case of bakery products, given the aerated structure of these products and the difficulty of obtaining a glutinous network which is stable and resistant to the phenomena of staling.

However, the Applicant has the merit of having succeeded in developing, after numerous trials, a food preparation which, once prepared, gives products resembling or imitating traditional bread-type products and which are at the same time rich in proteins, low in calories, organoleptically satisfactory, stable from the texture point of view, and easy to prepare.

Said food preparation is provided in the form of a fresh, deep-frozen, prebaked or baked dough. Most generally, it is provided in prebaked or baked form, at room temperature (the packaging being most generally carried out under a controlled atmosphere) or in a deep-frozen form, obviously requiring a baking step before consumption.

This dough may be shaped into balls, rolls, patties or baguettes, for example, before the prebaking or baking stages.

This dough is characterized in that it has, the percentages being expressed by weight on the commercial product:

a total protein content (measured as N×6.25) of between 5 and 25%, preferably between 6 and 23%, and still more preferably between 7 and 22%,

a carbohydrate content of between 10 and 27%, preferably between 10 and 26%, and still more preferably between 11 and 25%,

a lipid content of between 0.01 and 2%, preferably between 0.05 and 2%, and still more preferably between 0.09 and 1.75%,

a water content of 45 to 70%.

The total calorific value of the commercial product is between 90 and 200 kcal/100 g, preferably between 95 and 180 kcal/100 g and still more preferably between 95 and 178 kcal/100 g.

The food dough according to the invention is also characterized in that its chemical value is greater than 100. It is recalled that the expression chemical value is understood to mean the product by 100 of the smallest of the quotients obtained by dividing, for each of the essential amino acids or groups of essential amino acids, the quantity present in 100 g of product by the corresponding quantity present in 100 g of protein serving as reference, the latter being characterized by the following contents expressed relative to 100 g:

| | | |
|---|---|---|
| L isoleucine | 4 | g |
| L leucine | 7 | g |
| L lysine | 5.5 | g |
| DL methionine + L cystine | 3.5 | g |
| L phenylalanine + L tyrosine | 6 | g |
| L threonine | 4 | g |
| L tryptophan | 1 | g |
| L valine | 5 | g |

The proteins used for constituting the food dough in accordance with the invention may be of animal and/or plant origin.

It is preferable to use, as essential source of proteins (other than those obtained from flour) milk proteins, such as casein, caseinates, total milk protein, lactalbumin, whey. The total milk protein, obtained from skimmed milk by an ultrafiltration process ensuring nondenaturation of the proteins, is advantageously used. As and when necessary, it is possible also to add as protein, gluten, especially from wheat, or soybean proteins.

As carbohydrates, it is possible to use flours of any origin, any type of starch, of any origin, whether native or modified, in particular corn starches and wheat starches; sugars and polyols.

As lipids, it is preferable to use fat from copra, palm, soybean or sunflower in powdered or liquid form.

Of course, the dough in accordance with the invention may also contain other conventional ingredients such as flavorings, thickeners, amino acids, spices, condiments, taste enhancers, preservatives, colorings, vitamins, minerals, soluble or insoluble fibers such as in particular inulin or glucose or fructose polymers, emulsifiers, leavening powders and intense sweeteners; and it may contain, in addition, vegetable, meat, fish, cheese or fruit pieces or powder.

According to a preferred embodiment of the invention, the food preparation in dough form according to the invention contains:

from 8 to 30%, preferably from 8 to 28%, and still more preferably from 8.5 to 25% of milk proteins, total milk proteins being preferred,

a flour, preferably from wheat, in a quantity generally of between 13 and 35%, preferably between 14 and 33%, and still more preferably between 15 and 33%,

a leavening agent, such as baker's yeast, this leavening agent being most generally present in a quantity of between 0.2 and 1.2%, preferably between 0.25 and 1%, and still more preferably between 0.25 and 0.9%,

water, in a quantity of between 42 and 75%, preferably from 45 to 72%.

The subject of the invention is also the method for making the food preparation according to the invention, this method comprising the following steps:

selecting the ingredients, weighing and measuring out, said ingredients being for the most part in powdered form,

intimately mixing these ingredients with or without premixing,

adding water at room temperature to said mixture, with moderate and regular stirring, for example in a kneader, so as to lead to the formation of a connected and homogeneous dough,

rest time generally of between 5 minutes and 1 hour,

shaping,

rest time in a proof box or not, most generally of between 5 minutes and 3 hours,

baking or prebaking in a ventilated oven at a temperature of between 130° C. and 180° C., preferably of about 160° C., for a period of between 5 and 40 minutes, most generally in the region of 20 minutes,

deep-freezing or packaging under a controlled atmosphere.

In the case where the food preparation in accordance with the invention is intended to be sold directly in the form of raw dough, a deep-freezing step is carried out after the resting step in a proof box, and the baking step is then carried out directly by the consumer or the industrial manufacturer or the community.

As regards the shaping step, it may simply consist of shaping into rolls, balls, patties or baguettes, for example.

The invention will be understood more clearly with the aid of the following examples which are given purely by way of illustration.

### EXAMPLES

Several trials for the making of bread balls were carried out with the aid of the ingredients presented in Table 1 below. The addition of water and the mixing of the various ingredients were carried out in a kneader, the dough rest time was 2 hours and the baking was carried out in a ventilated oven at 160° C. for about 20 minutes.

TABLE 1

| Ingredients | Trial 1 | Trial 2 | Trial 3 | Trial 4 |
|---|---|---|---|---|
| Wheat flour type 55 | 40.71 | 42.9 | 42.9 | 29.77 |
| Calcium caseinate | 0 | 0 | 26.8 | 0 |
| 220 | | | | |
| (provided by the | | | | |
| company EPI) | | | | |
| Soybean protein | 0 | 26.8 | 0 | 0 |
| from | | | | |
| the company Lucas | | | | |
| Meyer | | | | |
| Total milk protein | 30 | 0 | 0 | 16.08 |
| PL 80 provided | | | | |
| by the | | | | |
| company Triballat | | | | |
| Salt | 1.27 | 1.35 | 1.35 | 0.78 |
| Yeast (company | 2.03 | 2.15 | 2.15 | 0.62 |
| Biospringer) | | | | |
| Water | 25.99 | 26.8 | 26.8 | 52.75 |
| Content of proteins | 29 | 27 | 28.4 | 15.87 |
| (Nx6.25) in % | | | | |
| Lipids (in %) | 1 | 0.8 | 0.95 | 0.58 |
| Carbohydrates | 21 | 20 | 20 | 22.1 |
| (in %) | | | | |
| General appearance | Rounded, | Not highly | Not at all | Homo- |
| after baking | raised, | raised, | homo- | geneous, |
| | homo- | falls | qeneous: | well |
| | geneous | again | crust | rounded, |
| | | during | rounded and | aerated, |
| | | baking. | separated | stable |
| | | Heavy and | from the | during |
| | | thick | crumb | baking |
| | | | (formation | |
| | | | of a large | |
| | | | bubble in | |
| | | | the middle | |
| | | | of the | |
| | | | product) | |
| Appearance of the | Baked, | Moist, not | Not baked | Baked, |
| crumb | stable | highly | at all, | stable, |
| | | baked | gelatinous | white color |
| Appearance of the | Distinct | Too moist | Very red | Distinct |
| crust | from the | and | color, | from the |
| | crumb | elastic | distinct | crumb, well |
| | | | from the | baked, |
| | | | crumb | brown |
| | | | | color, dark |
| | | | | and |
| | | | | homo- |
| | | | | geneous |
| Taste | Fairly | Very | Very poor | Excellent |
| | neutral | vegetable- | | |
| | | like | | |

The following remarks may be made in relation to these trials.

Trial 1 gives results which are roughly satisfactory, but nevertheless the calorific value of the product is still too high and the taste is not satisfactory.

The use of soybean protein in place of total milk protein gives poor results.

The use, in Trial 3, of calcium caseinate in place of total milk protein also gives unsatisfactory results.

Trial 4 corresponds to the invention. It can be observed that the flour content has been very markedly reduced compared with a conventional product. The use of total milk protein, that is to say of protein obtained after removal of most of the lactose, allows the production of a product of homogeneous structure, which is well aerated, stable and having an excellent taste. The use of this protein also makes it possible to obtain an appropriate brown color of the crust, which brings the product in accordance with the invention closer to traditional bakery products.

1. A high protein and low calorie food preparation in the form of dough suited to shaping, in particular into rolls, balls, patties or baguettes, for making products imitating or resembling traditional bread-type products, characterized in that it has, the percentages being expressed by weight on the commercial product:
a total protein content (measured in N×6.25) of between 5 and 25%, preferably between 6 and 23%, and still more preferably between 7 and 22%,
a carbohydrate content of between 10 and 27%, preferably between 10 and 26%, and still more preferably between 11 and 25%,
a lipid content of between 0.01 and 2%, preferably between 0.05 and 2%, and still more preferably between 0.09 and 1.75%,
a total milk protein content of between 8 and 30%, preferably between 8 and 28%, and still more preferably between 8.5 and 25%,
a water content of 45 to 70%.

2. The food preparation as claimed in claim 1, characterized in that it comprises a flour, preferably from wheat, in a quantity of between 13 and 35%, preferably between 14 and 33%, and still more preferably between 15 and 33%, these percentages being expressed by weight relative to the commercial product.

3. The food preparation as claimed in any one of claims 1 to 2, characterized in that it contains a leavening agent, preferably baker's yeast, in a quantity of between 0.2 and 1.2%, preferably between 0.25 and 1%, and still more preferably between 0.25 and 0.9%.

4. The food preparation as claimed in any one of claims 1 to 3, characterized in that the total calorific value of the commercial product is between 90 and 200 Kcalories per 100 g, preferably between 95 and 180 Kcalories per 100 g, and still more preferably between 95 and 178 Kcalories per 100 g.

5. The food preparation as claimed in any one of claims 1 to 4, characterized in that its chemical value is greater than 100.

6. A method for making a food preparation as claimed in any one of claims 1 to 5, characterized in that it comprises the following steps:
selecting the ingredients, weighing and measuring out, said ingredients being for the most part in powdered form,
intimately mixing these ingredients with or without premixing,
adding water at room temperature to said mixture, with moderate and regular stirring, for example in a kneader, so as to lead to the formation of a connected and homogeneous dough,
rest time generally of between 5 minutes and 1 hour,
shaping,
rest time in a proof box or not, most generally of between 5 minutes and 3 hours,
baking or prebaking in a ventilated oven at a temperature of between 130° C. and 180° C., preferably of about 160° C., for a period of between 5 and 40 minutes, most generally in the region of 20 minutes,
deep-freezing or packaging under a controlled atmosphere.

7. A method for making a food preparation as claimed in any one of claims 1 to 5, characterized in that it comprises the following steps:
selecting the ingredients, weighing and measuring out, said ingredients being for the most part in powdered form,
intimately mixing these ingredients with or without premixing,
adding water at room temperature to said mixture, with moderate and regular stirring, for example in a kneader, so as to lead to the formation of a connected and homogeneous dough,
rest time generally of between 5 minutes and 1 hour,
shaping,
rest time in a proof box or not, most generally of between 5 minutes and 3 hours,
deep-freezing,
packaging.

8. A bakery product obtained using the food preparation as claimed in any one of claims 1 to 5.
